(19) United States
(12) Patent Application Publication
(10) Pub. No.: US 2026/0121369 A1
(43) Pub. Date: Apr. 30, 2026

(54) MEASUREMENT AND CONTROL OF THE FREQUENCY OF AN OPTICAL SIGNAL

(71) Applicant: Toptica Photonics SE, Gräfelfing (DE)

(72) Inventors: Manfred HAGER, München (DE); Pierre THOUMANY, München (DE)

(73) Assignee: Toptica Photonics SE, Gräfelfing (DE)

(21) Appl. No.: 19/369,405

(22) Filed: Oct. 27, 2025

(30) Foreign Application Priority Data
Oct. 25, 2024 (DE) 10 2024 131 261.0

(51) Int. Cl. H01S 3/13; G01J 9/04

(52) U.S. Cl. CPC H01S 3/1305; G01J 9/04

(57) ABSTRACT

The disclosure relates to a method for determining the frequency of an optical signal. The method is intended to enable precise frequency determination with improved dynamics compared to the prior art. It should be possible to unequivocally determine the frequency of the optical signal over a wide frequency range. For this, the method comprises the following steps:
Generation of an in-phase (I) and a quadrature signal (Q) by heterodyne optical quadrature detection, wherein the optical signal is superimposed with an optical reference signal whose spectrum is an optical frequency comb, and the in the process resulting beat signals are detected,
converting the analog in-phase (I) and quadrature signals (Q) into digital signals with a sampling rate equal to the frequency spacing (f_{R}) between adjacent spectral lines of the frequency comb, and
determining the frequency spacing (f_{L}) between the frequency (v_{CW}) of the optical signal and the frequency (v_{FC}) of one of the spectral lines of the frequency comb by processing the digital in-phase and quadrature signals. The disclosure also relates to a method for controlling the frequency (v_{CW}) of an optical signal, as well as a laser system.

### RELATED APPLICATION(S)

This application claims the benefit of priority of German Patent Application No. DE10 2024 131 261.0 filed Oct. 25, 2024, the contents of which are incorporated by reference as if fully set forth herein in their entirety.

### FIELD AND BACKGROUND OF THE INVENTION

The disclosure relates to a method for determining and for controlling the frequency of an optical signal. The disclosure also relates to a laser system that uses such a method.

In the field of metrological optics, it is known to determine precisely the frequency of an optical signal, such as the frequency of the radiation of a continuously emitting (cw) laser, using an optical frequency comb. The optical frequency comb serves hereby as a highly accurate reference, whose discrete, equidistant spectral lines represent a “ruler scale” in the optical frequency range, so to speak. The frequency determined in this way can be used as the basis for controlling the frequency of the optical signal to a target frequency by means of a controller that adjusts the optical frequency in accordance with a control deviation resulting from the frequency determination and a control variable derived accordingly from it.

An optical frequency comb is known to describe an optical spectrum consisting of equidistant spectral lines (also referred to as comb lines). An optical frequency comb can be generated, for example, by means of a short-pulse laser light source, which typically emits laser pulses with a pulse duration in the picosecond or femtosecond range and with a repetition rate f_{R} in the MHz range to GHz range. It is also known to generate an optical frequency comb by modulating continuously emitted laser radiation (for example, a so-called EOM-comb), where f_{R} is the modulation frequency, which in turn can be in the MHz range to GHz range. The frequency spacing between adjacent spectral lines of the frequency comb is then equal to f_{R}. The frequency v_{FC} of the n-th spectral line of the frequency comb can be described by the relationship v_{FC}=n×f_{R}+f_{ceo}, wherein f_{ceo} is the so-called carrier envelope offset frequency.

Typically, the optical signal, for example, the radiation from a narrow-band light source or a cw-laser whose frequency is to be determined, is superimposed with the frequency comb in a heterodyne detection scheme. The frequency of the optical signal is hereby close to one of the spectral lines of the frequency comb. Superimposing the radiation of the optical signal with the optical frequency comb creates interference, which results in a beat signal. The beat signal is converted by a sufficiently fast photodiode into a high-frequency electrical signal whose frequency, which lies in the MHz range to GHz range, corresponds to the frequency difference between the frequency of the optical signal (v_{CW}) and the nearest spectral line of the comb. The beat signal (Schwebungssignal) has a frequency of f_{B}=|v_{CW}−v_{FC}|. In order to determine the absolute frequency of the cw-laser, the frequency v_{FC} of the relevant spectral line of the frequency comb must be known. This results in v_{CW}=v_{FC}±f_{B}.

Here, a disadvantage of the known method can already be seen. Without additional measures, the sign in the last equation is unknown, that is, the frequency f_{B} of the beat signal does not allow any conclusions to be drawn as to whether the frequency of the optical signal, that is, the radiation of the cw-laser, lies below or above the spectral line of the optical frequency comb used as a reference in the spectrum.

Another disadvantage results from the fact that the optical signal, that is, the radiation of the cw-laser, interferes not only with the selected spectral line, but also with other neighboring spectral lines of the frequency comb. As a result, several beat frequencies are detected that cannot be clearly assigned without additional measures. Unequivocal assignment is only possible within a frequency range that corresponds to half the repetition rate f_{R}, that is, half the spacing of the spectral lines of the frequency comb. The dynamics of frequency determination are thus comparatively limited.

### SUMMARY OF THE INVENTION

The disclosure provides a method for determining the frequency of an optical signal, comprising the following steps:
Generation of an in-phase and a quadrature signal by heterodyne optical quadrature detection, wherein the optical signal is superimposed with an optical reference signal whose spectrum is an optical frequency comb, and the in the process resulting beat signals are detected, and
converting the analog in-phase and quadrature signals into digital signals with a sampling rate equal to the frequency spacing between adjacent spectral lines of the frequency comb.

### BRIEF DESCRIPTION OF THE SEVERAL VIEWS OF THE DRAWING(S)

Examples of embodiments of the disclosure are explained in more detail below with reference to the drawings. They show:

FIG. 1 Illustration of the conventional principle of heterodyne detection for determining the frequency of an optical signal using an optical frequency comb;

FIG. 2 Illustration of the method according to the disclosure for removing unwanted frequency components from the beat signal;

FIG. 3 Block diagram of a first embodiment example of a laser system according to the disclosure;

FIG. 4 Illustration of the method used in the disclosure for unequivocally determining the beat frequency;

FIG. 5 Block diagram of a second embodiment example of a laser system according to the disclosure;

FIG. 6 Block diagram of a third embodiment example of a laser system according to the disclosure;

FIG. 7 Block diagram of a fourth embodiment example of a laser system according to the disclosure.

### DESCRIPTION OF SPECIFIC EMBODIMENTS OF THE INVENTION

The disclosure provides a method for determining the frequency of an optical signal, comprising the following steps:
Generation of an in-phase and a quadrature signal by heterodyne optical quadrature detection, wherein the optical signal is superimposed with an optical reference signal whose spectrum is an optical frequency comb, and the in the process resulting beat signals are detected,
converting the analog in-phase and quadrature signals into digital signals with a sampling rate equal to the frequency spacing between adjacent spectral lines of the frequency comb, and
determining the frequency spacing between the frequency of the optical signal and the frequency of one of the spectral lines of the frequency comb by processing the digital in-phase and quadrature signals.

As explained above, the absolute value of the frequency of the optical signal can be determined by knowing the frequency of the respective spectral line (the one closest to the frequency of the optical signal) of the frequency comb. However, it should be noted that in various applications for frequency determination, it is sufficient to determine only the frequency difference, that is, the beat frequency between the frequency of the optical signal and the frequency of the respective spectral line of the frequency comb. For example, when the frequency of the optical signal changes, only the exact value of the frequency change, that is, the frequency deviation, may be of interest, but not the absolute value of the frequency. Therefore, the disclosure understands “determination of the frequency” to mean only the determination of the frequency offset relative to a spectral line of the frequency comb, without being limited to the determination of the absolute value of the frequency of the optical signal.

In principle, the disclosure uses a heterodyne detection scheme as described above, in which the optical signal (for example, laser radiation emitted by a cw-laser) whose frequency v_{CW} is to be determined is superimposed with the optical reference signal whose spectrum is a frequency comb. However, unlike the conventional approach, the disclosure uses optical quadrature detection. Optical quadrature detection is used to obtain information about the frequency and phase of the optical signal in relation to the reference signal. It enables the complex electric field of the optical signal to be analyzed. Quadrature detection detects two orthogonal components (quadratures) of the electric field of the optical signal. These quadratures are comparable to the real and imaginary parts of a complex number describing the electric field. These two quadratures are referred to here as the in-phase signal (real part, hereinafter short I-signal) and the quadrature signal (imaginary part, hereinafter short Q-signal). Quadrature detection can be used to determine whether the frequency of the optical signal is above or below the nearest spectral line of the frequency comb.

In heterodyne optical quadrature detection, the optical signal is superimposed, for example, with the optical reference signal on a first photodetector (I-detector) without phase shift and on a second photodetector (Q-detector) with a 90° phase shift between the two signals in order to obtain two beat signals, namely the I-signal and the Q-signal.

In addition, the disclosure resolves the ambiguities in determining the frequency spacing that previously limited the measuring range by means of digital signal processing, whereby the analog I-signals and Q-signals detected by the photodetectors are digitized that is, sampled to obtain digital, time-discrete I-signals and Q-signals with a sampling frequency equal to the repetition rate. According to the sampling theorem, this results in a spectral bandwidth of the digital I-signals and Q-signals that is equal to half the repetition rate. This approach specifically exploits the aliasing that occurs during subsampling in order to achieve that further frequency components of the beat signals, that is, the I-signals and Q-signals resulting from the interference of the optical signal with other neighboring spectral lines of the optical frequency comb, are transferred to the frequency range of the digital I-signals and Q-signals in such a way that they each contain only exactly one frequency component, namely at the beat frequency of interest, which corresponds to the frequency spacing sought.

In combination with quadrature detection, it is possible to precisely and unequivocal determine the frequency of the optical signal over the full frequency spacing between two adjacent spectral lines of the optical frequency comb, despite the under-sampling during the generation of the digital I-signals and Q-signals. The frequency spacing can be determined unequivocally over the entire frequency interval by determining the phase of the complex-valued beat signal formed by the in-phase signal and the quadrature signal, even though the spectral bandwidth of the digital I-signals and Q-signals is limited to half the repetition rate. Further details on this are explained below.

In a useful design, low-pass filtering of the beat signals is performed with a cutoff frequency in the range between half and the full frequency spacing between the spectral lines of the reference signal, that is, between the half and the full repetition rate, in order to suppress frequency components of the analog I-signals and Q-signals at higher frequencies. Since the beat frequency, i.e., the frequency interval of interest, is derived from the I-signals and Q-signals only in the frequency interval up to half the repetition rate, low-pass filtering suppresses unnecessary signal components and thus improves the signal-to-noise ratio.

In a further useful embodiment, the determination of the phase comprises the detection of phase jumps of ±2π during a continuous change in the frequency of the optical signal (for example, when tuning the cw-laser) and making a correction that takes into account the fact that the determined frequency difference refers to the next higher or next lower spectral line in the frequency comb with each phase jump, depending on the direction of the change in the frequency of the optical signal. It can be seen that the phase of the complex-valued signal makes jumps of ±2π when the frequency of the optical signal changes, thereby moving away from the spectral line of the frequency comb that was originally closest and approaching the next neighboring spectral line. More precisely, the phase jump occurs when the frequency of the optical signal passes the middle of the frequency interval between two adjacent spectral lines of the optical frequency comb during the change. The correction can be made, for example, by continuously continuing the frequency spacing determined during the change. The frequency jumps can be conveniently “counted” by digital signal processing in order to track how many spectral lines the frequency of the optical signal has “covered” during the change. This can then be incorporated into the frequency determination, that is, into the determination of the current absolute frequency of the optical signal or into the determination of the relative frequency change in the sense of a continuous continuation.

In one possible design, the frequency difference, that is, the beat frequency, is determined by means of a complex-valued phase-locked loop (also known as a “quadrature phase-locked loop”—QPLL). The complex-valued phase-locked loop works with an internal reference signal that comprises two signals phase-shifted by 90°, which can be interpreted as a complex-valued signal. By mixing these two signals with the I-signals and Q-signals, the QPLL provides an error value that takes into account not only the frequency deviation but also the phase deviation. The QPLL locks when the internal reference signal matches the I-signals and Q-signals in terms of frequency and phase. From this, it can be unequivocally concluded whether the frequency of the optical signal is above or below the nearest spectral line of the frequency comb. In other words, the phase-locked loop determines the sign of the beat frequency and thus ensures unequivocal frequency determination.

The method described above for determining the frequency of the optical signal can be used to control it to a target frequency. Accordingly, the disclosure also relates to a method for controlling the frequency of an optical signal, having the following steps:
Derivation of a control deviation from the frequency of the optical signal, determined according to the method described above, by comparison with a target frequency,
deriving a control variable from the control deviation, and
adjusting the frequency of the optical signal in accordance with the control variable.

The disclosure also relates to a laser system with
a first, for example continuously emitting (cw) laser radiation source, intended to emit an optical signal at a frequency,
a second laser radiation source, for example a short-pulse laser radiation source, intended to emit an optical reference signal whose spectrum is an optical frequency comb, wherein the distance between adjacent spectral lines of the frequency comb is equal to a repetition rate,
an optical quadrature detector with two photodetectors, intended to detect beat signals generated on the photodetectors by superimposing the optical signal with the optical reference signal as in-phase signals and quadrature signals according to the principle of heterodyne optical quadrature detection,
two analog-to-digital converters associated with the photodetectors, intended to convert the analog in-phase signals and quadrature signals into digital, time-discrete signals with a sampling rate equal to the repetition rate, and
a digital signal processing device intended to determine the frequency difference between the frequency of the optical signal and the frequency of one of the spectral lines of the reference signal by processing the digital in-phase signals and quadrature signals.

The photodetectors may each be assigned low-pass filters intended to subject the beat signals to low-pass filtering with a cutoff frequency in the range between the half and the full value of the repetition frequency, as described above.

The digital signal processing device may be intended to perform an arctangent operation to determine the phase of the complex-valued detected beat signal given by the in-phase signal and the quadrature signal. The digital signal processing device can then determine the frequency spacing unequivocally by taking the phase into account in a frequency interval whose spectral width is equal to the repetition rate. In other words, determining the phase allows positive and negative beat frequencies to be distinguished. The digital signal processing device may further be designed to detect phase jumps of ±2π and to make a correction in order to continuously continue the course of the determined frequency spacing in the event of a continuous change in the frequency of the optical signal, as explained above.

To determine the frequency offset, the digital signal processing device may comprise a complex-valued digital phase-locked loop for determining the frequency offset. The digital signal processing device with phase-locked loop may be implemented, for example, as an FPGA, so that very fast signal processing and frequency determination is possible virtually “in real time.”

Furthermore, the digital signal processing device may comprise a control system designed to derive a control deviation from the determined frequency deviation by comparison with a predetermined target frequency. Thereby the control system may be intended to derive a control variable from the control deviation, which is fed back to the continuously emitting (cw) laser radiation source for adjustment of the frequency of the optical signal. This allows a system to be implemented in which the frequency of the cw-laser follows the target frequency with high precision across any number of spectral lines of the optical frequency comb. This means that precise “frequency scans” of the cw-laser over wide spectral ranges are possible.

The FIG. 1a shows four spectral lines of an optical reference signal as an example on the top whose spectrum is an optical frequency comb. The frequency spacing between adjacent spectral lines is equal to the repetition rate f_{R}. The frequency v_{FC} of the n-th spectral line of the frequency comb is given by the relationship v_{FC}=n×f_{R}+f_{ceo}. The lower diagram shows the spectrum of an optical signal, namely the radiation of a cw-laser, with a spectral line at the frequency v_{CW}. If the radiation of the cw-laser, whose frequency v_{CW} is to be determined, is superimposed with the frequency comb in a heterodyne detection scheme, a beat signal results with a multitude of frequency components corresponding to the differences between the optical frequencies present. These are indicated in FIG. 1a with vertical dashed lines. The frequency components of the beat signal are shown in the diagram in FIG. 1b. In FIG. 1a, the frequency v_{CW} of the cw-laser is close to one of the spectral lines (the second spectral line from the left) of the frequency comb, so that the lowest beat frequency occurring is the frequency f_{B}, which corresponds to the frequency difference between the frequency v_{CW} of the optical signal and the frequency of this spectral line of the frequency comb. Further frequency components of the beat signal arise from interference with more distant spectral lines of the frequency comb and from interference between the spectral lines of the frequency comb themselves. Some of these spectral components are shown in the diagrams. These are at f_{R}−f_{B}, f_{R}, f_{R}+f_{B}, 2f_{R}−f_{B}, 2f_{R}, et cetera. As explained above, these frequency components of the beat signal do not allow a clear conclusion to be drawn about the frequency vow of the optical signal of interest, for example, it is not possible to determine with certainty whether the frequency vow in the spectrum lies below or above the nearest spectral line of the frequency comb.

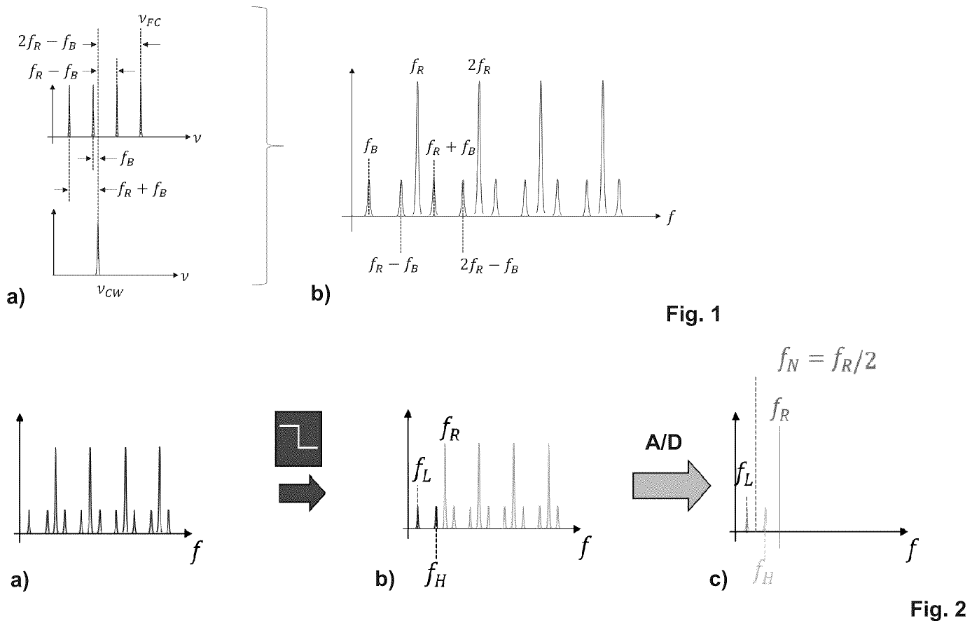

The FIG. 2 first illustrates the method used in the disclosure for elimination of unwanted frequency components of the beat signal. The diagram in FIG. 2a, which corresponds to that in FIG. 1b, represents the starting point. In a first step, low-pass filtering is performed with a cutoff frequency at f_{R} to remove all higher-frequency components. This is indicated in FIG. 2b. Only the frequency components at f_{L}=f_{B} and f_{H}=f_{R}−f_{B} remain. In a second step, the beat signal is digitized with a sampling rate equal to the repetition rate f_{R}. The resulting Nyquist frequency f_{N}=f_{R}/2, according to the sampling theorem, is plotted in the diagram in FIG. 2c. Aliasing causes the frequency component at f_{H} in the digital signal to be transferred exactly to the frequency component at f_{L}, so that the digital signal now has only a single frequency component at the beat frequency of interest f_{L}=f_{B}. This is because the frequency components f_{L} and f_{H} in the spectrum of the beat signal are arranged symmetrically to the Nyquist frequency f_{N}=f_{R}/2.

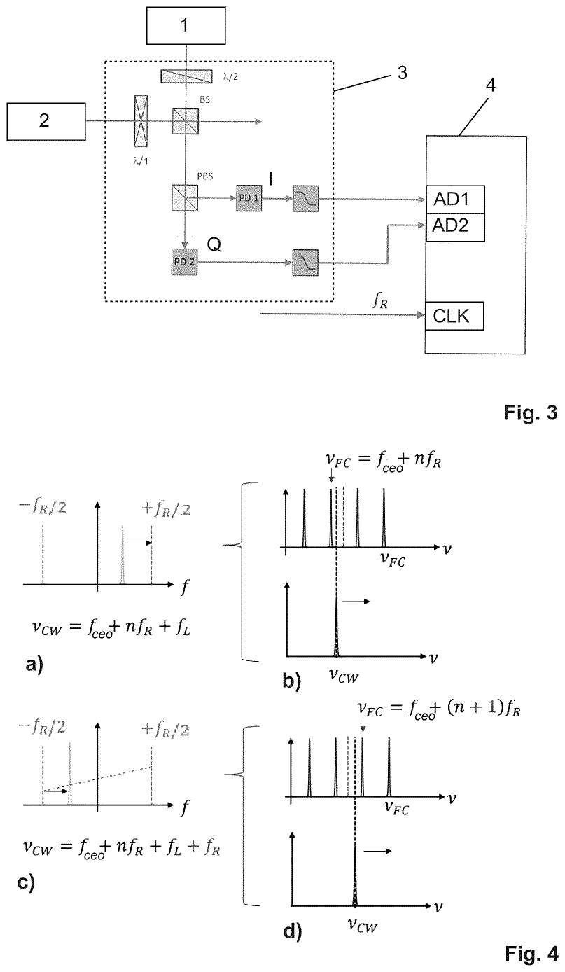

FIG. 3 shows a block diagram of a first embodiment example of a laser system according to the disclosure. This comprises a cw-laser radiation source 1, which emits an optical signal at a frequency v_{CW} to be determined (see lower diagram of FIG. 1a). A short-pulse laser radiation source 2 is also provided, which emits an optical reference signal whose spectrum is an optical frequency comb (see upper diagram of FIG. 1a). An optical quadrature detector 3 with two photodetectors PD1, PD2 is provided to detect beat signals generated on the photodetectors PD1, PD2 by superimposing the optical signal of the cw-laser 1 with the optical reference signal of the short-pulse laser 2 as in-phase signals I and quadrature signals Q according to the principle of heterodyne quadrature detection. The quadrature detection is performed in order to determine whether the frequency v_{CW} of the optical signal of the cw-laser 1 is above or below the nearest spectral line of the frequency comb. For optical quadrature detection, the two quadrature signals I and Q are generated using the λ/2 and λ/4 waveplates shown in FIG. 3 and a polarization beam splitter PBS. The high-frequency electrical signals I and Q at the outputs of the two photodetectors PD1 and PD2 each pass through a low-pass filter, as explained previously in FIG. 2. The analog signals are then fed to the respective analog-to-digital converters AD1 and AD2, which convert the analog I and Q signals into digital, time-discrete signals at a sampling rate equal to the repetition rate f_{R}, as also explained previously in FIG. 2. For this purpose, a high-frequency signal with the frequency f_{R} is fed as a clock signal CLK for sampling, which can be derived directly from the laser pulse train of the short-pulse laser 2. The analog-to-digital converters AD1, AD2 are part of a digital signal processing device 4 that is set up (for example by corresponding programming of a microcontroller, a digital signal processor, a desktop PC, or an FPGA) to determine the frequency difference fs between the frequency of the optical signal v_{CW} and the frequency v_{FC} of the nearest spectral lines of the frequency comb by digitally processing the I-signals and Q-signals, and unequivocally within a frequency range f_{R} corresponding to the spacing between two spectral lines of the frequency comb.

Through the digital signal processing of the I-signals and Q-signals, the phase of the complex-valued digital beat signal is determined in for example as the arctangent of the quotient of the Q-signals and I-signals, that is, φ=a tan (Q/I). This phase immediately reveals whether the beat frequency f_{B} is positive or negative, that is, whether the frequency vow of the optical signal is above or below the nearest spectral line of the frequency comb. This is illustrated in FIG. 4. FIGS. 4a and 4c show the frequency interval from −f_{R}/2 to +f_{R}/2 in which the beat frequency can be unequivocally determined by quadrature detection. FIG. 4a corresponds to the situation shown in FIG. 4b, in which the frequency v_{CW} to be determined lies slightly above the spectral line of the frequency comb at v_{FC}=f₀+nf_{R}. Accordingly, the beat frequency f_{L}=f_{B} is positive in the diagram in FIG. 4a. Consequently, the frequency sought is v_{CW}=f₀+nf_{R}+f_{L}. If the frequency v_{CW} is now changed to higher frequencies, as indicated by the arrows pointing to the right in FIGS. 4a and 4b, the frequency of the beat signal in the diagram in FIG. 4a also moves to higher values. As soon as the frequency v_{CW} exceeds the middle of the interval between two adjacent spectral lines of the frequency comb (dashed vertical line in the upper diagrams of FIGS. 4b and 4d), the next higher-frequency spectral line of the frequency comb at v_{FC}=f₀+(n+1)f_{R} is the spectral line closest to the frequency v_{CW}. As indicated in FIG. 4c, the phase undergoes a phase jump of −2π, that is, the beat frequency f_{L} becomes negative (with the same magnitude), since the frequency v_{CW} is now below the closest spectral line of the frequency comb, as can be seen in FIG. 4d. Consequently, the frequency of the optical signal is now given by v_{CW}=f₀+nf_{R}+f_{L}+f_{R}. The same applies when the frequency v_{CW} is reduced, that is, when it changes to lower values. In this case, the phase shows a phase jump of +2π, which must be taken into account accordingly when determining the frequency v_{CW}. The digital signal processing device 4 must be designed accordingly to detect the phase jumps of ±2π in the event of a continuous change in the frequency v_{CW} of the optical signal and to continue the resulting curve continuously when determining the frequency v_{CW}.

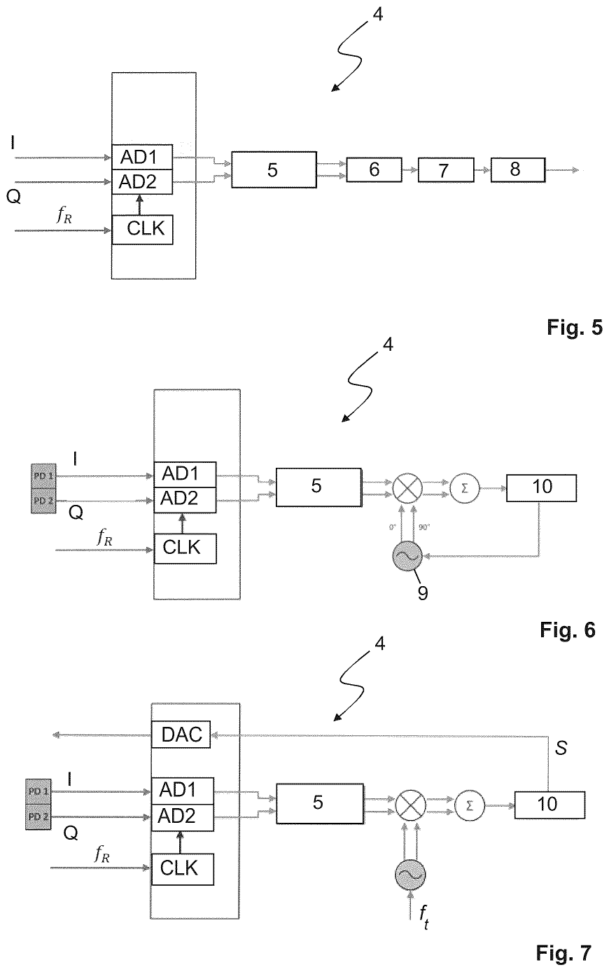

A suitable design for this purpose of the digital signal processing device 4 of the laser system according to the disclosure is shown in FIG. 5. The combination of the I-signals and Q-signals can be understood as a complex number from which the instantaneous phase of the beat signal can be derived. First, the digital I-signals and Q-signals undergo signal conditioning at 5 to remove a DC component and to align to each other the signal amplitudes of the I-signals and Q-signals. The subsequent arctangent operation at 6 determines the phase of the complex-valued signal formed by the I-signals and Q-signals. Since the value range of this operation is limited to +−π, the individual phase ranges are then continuously connected to each other at 7. This enables a continuous phase curve, as explained above. The frequency offset f_{L} is then determined unequivocally at 8 in the range from −f_{R}/2 to +f_{R}/2.

The implementation according to FIG. 5 is well suited for realization as a post-processing method (for example, on a desktop PC). However, efficient implementation in a real-time system (for example, via FPGA) is practically impossible. A suitable approach for this is shown in FIG. 6. Here, a complex-valued digital phase-locked loop (“tracking PLL”) is used to determine the frequency offset f_{L}. An oscillator 9 generates two signals at a controllable frequency as an internal reference, which differ by 90° in terms of their phase. The two signals are mixed with the I-signals and Q-signals (each individually). The added output signals of the mixer are fed to a controller 10, which controls the oscillator 9 in such a way that the phase-locked loop locks onto the I and Q signals, that is, the signals of the internal reference match the I-signals and Q-signals in terms of frequency and phase. The frequency generated in the phase-locked loop corresponds to the (positive or negative) beat frequency f_{L}.

In variant 7, the complex-valued phase-locked loop is modified in order to use the approach of the disclosure to frequency determination to specify a temporal frequency response of the cw-laser 1. The oscillator 9 specifies a target frequency fₜ corresponding to an external input. The added output signals of the mixer then represent a control deviation signal, which is fed to the controller 10. The controller generates a digital control signal S from this, which is fed back to the cw-laser 1 after passing through a digital-to-analog converter DAC (indicated by the arrow in FIG. 7). The controller 10 varies the frequency v_{CW} via the control signal S until the control deviation disappears, that is, the frequency v_{CW} assumes the desired value (for example, the frequency of the nearest spectral line of the frequency comb plus target frequency fₜ). In this case, the arrangement according to the disclosure for determining the frequency serves as a sensor in a control loop for determining the current control deviation.

The embodiments of FIGS. 3, 5, 6, and 7 are shown schematically as block diagrams. The specific implementation can be carried out in any manner familiar to those skilled in the art. For example, implementations with optical free-beam paths as well as wholly or partially fiber-based implementations are possible.

The disclosure provides a precise method for determining the frequency of an optical signal that avoids at least some of the aforementioned disadvantages. High-precision frequency determination with improved dynamics compared to the prior art is possible, that is, the unequivocal determination of the frequency of the optical signal over a larger frequency range.

What is claimed is:

1. Method for determining the frequency of an optical signal, comprising the following steps:
Generation of an in-phase (I) and a quadrature signal (Q) by heterodyne optical quadrature detection, wherein the optical signal is superimposed with an optical reference signal whose spectrum is an optical frequency comb, and the in the process resulting beat signals are detected, converting the analog in-phase (I) and quadrature signals (Q) into digital signals with a sampling rate equal to the frequency spacing (f_{R}) between adjacent spectral lines of the frequency comb, and
determining the frequency spacing (f) between the frequency of the optical signal and the frequency (v_{FC}) of one of the spectral lines of the frequency comb by processing the digital in-phase and quadrature signals.

2. Method according to claim 1, wherein the optical signal is laser radiation generated by a continuously emitting (cw) laser at a frequency (v_{CW}) to be determined.

3. Method according to claim 1, further comprising low-pass filtering of the beat signals with a cutoff frequency in the range between half and the full frequency spacing (f_{R}) between the spectral lines of the reference signal.

4. Method according to claim 1, wherein the frequency difference (f_{L}) between the frequency (v_{CW}) of the optical signal and the frequency (v_{FC}) of one of the spectral lines of the frequency comb is determined, which is at most equal to the frequency difference (f_{R}) of adjacent spectral lines of the frequency comb.

5. Method according to claim 4, wherein the frequency spacing (f_{L}) is determined unequivocally in a frequency interval by determining the phase of the complex-valued signal formed by the in-phase (I) and the quadrature (Q) signal, the spectral width of which is equal to the frequency spacing (f_{R}) of two adjacent spectral lines of the frequency comb.

6. Method according to claim 5, wherein the determination of the phase comprises the detection of phase jumps of ±2π during a continuous change in the frequency (v_{CW}) of the optical signal and the application of a correction which takes into account that the determined frequency spacing (f_{L}) refers to the next higher or next lower spectral line in the frequency comb with each phase jump, depending on the direction of the change in frequency (v_{CW}) of the optical signal.

7. Method according to claim 1, wherein the frequency spacing (f_{L}) is determined by means of a complex-valued digital phase-locked loop.

8. Method for controlling the frequency (v_{CW}) of an optical signal, having the following steps:
Derivation of a control deviation from the frequency (v_{CW}) of the optical signal, determined according to the method according to claim 1, by comparison with a target frequency (fₜ),
deriving a control variable(S) from the control deviation, and
adjusting the frequency (v_{CW}) of the optical signal in accordance with the control variable(S).

9. Laser system, with
a first, for example continuously emitting (cw) laser radiation source (1), intended to emit an optical signal at a frequency (v_{CW}),
a second laser radiation source, for example a short-pulse laser radiation source (2), intended to emit an optical reference signal whose spectrum is an optical frequency comb, wherein the distance between adjacent spectral lines of the frequency comb is equal to a repetition rate (f_{R}),
an optical quadrature detector (3) with two photodetectors (PD1, PD2), intended to detect beat signals generated on the photodetectors (PD1, PD2) by superimposing the optical signal with the optical reference signal as in-phase and quadrature signals according to the principle of heterodyne quadrature detection,
two analog-to-digital converters (ADC1, ADC2) associated with the photodetectors (PD1, PD2), intended to convert the analog in-phase and quadrature signals (I, Q) into digital, time-discrete signals at a sampling rate equal to the repetition rate (f_{R}), and
a digital signal processing device (4) designed to determine the frequency difference (f_{L}) between the frequency (v_{CW}) of the optical signal and the frequency (v_{FC}) of one of the spectral lines of the reference signal by processing the digital in-phase and quadrature signals.

10. Laser system according to claim 9, with two low-pass filters assigned to each of the photodetectors (PD1, PD2), intended to subject the beat signals to low-pass filtering with a cutoff frequency in the range between half and the full value of the repetition frequency (f_{R}).

11. Laser system according to claim 9, wherein the digital signal processing device (4) is intended to perform an arctangent operation in order to determine the phase of the complex-valued signal formed by the in-phase signal (I) and the quadrature signal (Q).

12. Laser system according to claim 11, wherein the digital signal processing device (4) is further intended to determine the frequency spacing (f_{L}) by taking into account the phase unequivocally in a frequency interval whose spectral width is equal to the repetition rate (f_{R}) by taking the phase into account.

13. Laser system according to claim 11, wherein the digital signal processing device (4) is further intended to detect phase jumps of ±2π and to perform a correction in order to continuously continue the course of the determined frequency spacing (f_{L}) during a continuous change in the frequency (v_{CW}) of the optical signal.

14. Laser system according to claim 9, wherein the digital signal processing device (4) comprises a complex-valued digital phase-locked loop for detecting the frequency offset (f_{L}).

15. Laser system according to claim 9, wherein the digital signal processing device (4) comprises a controller designed to derive a control deviation from the determined frequency deviation (f_{L}) by comparison with a predeterminable target frequency (fₜ).

16. Laser system according to claim 15, wherein the controller is further intended to derive a control variable (S) from the control deviation, which is fed back to the continuously emitting laser radiation source (1) for adjusting the frequency (v_{CW}) of the optical signal.
